(19) United States
(12) Patent Application Publication
(10) Pub. No.: US 2025/0364619 A1
(43) Pub. Date: Nov. 27, 2025

(54) METHOD AND SYSTEM FOR DESIGNING A HEAT SHIELD FOR A HIGH VOLTAGE BATTERY OF A VEHICLE

(71) Applicant: FCA US LLC, Auburn Hills, MI (US)

(72) Inventors: Dipa Pradeepkumar Arora, Sterling Heights, MI (US); Alaa Edeen El-Sharkawy, West Bloomfield, MI (US); Amr Gamal Samy Sayed, 6th of October City (EG)

(21) Appl. No.: 18/670,304

(22) Filed: May 21, 2024

(51) Int. Cl. H01M 10/617; G06F 30/27; G06F 30/28; G06F 119/08; G06F 119/12; H01M 10/625

(52) U.S. Cl. CPC H01M 10/617; G06F 30/27; G06F 30/28; H01M 10/625; G06F 2119/08; G06F 2119/12; H01M 2220/20

(57) ABSTRACT

A method and system for designing a heat shield includes performing a thermal runaway analysis for a first battery pack design to obtain thermal runaway data, determining an initial heat shield design, determining vehicle analysis data using the thermal runaway data an ambient air temperature and a vehicle velocity and comparing the vehicle analysis data to design constraint data and safety data to obtain design guide performance parameters.

### FIELD

The present disclosure relates to a heat shield for a high voltage battery, and, more specifically, to a system and method and system for developing a design for a heat shield.

### BACKGROUND

This section provides background information related to the present disclosure which is not necessarily prior art.

High-voltage batteries are used in electric vehicles are used in battery electric and hybrid vehicles. In some operating states, the batteries may experience elevated temperatures. To prevent the elevated temperatures from reaching components like cables, fuel lines, brake lines and interior trim, heat mitigation is employed. Typically, a heat shield is employed.

Traditional approaches to battery heat shield design rely on empirical testing, simplified heat transfer calculations, non-comprehensive physics simulation, and fireproof materials. These methods can be time-consuming, resource-intensive, and lack accuracy in predicting complex transient temperature profiles during elevated temperatures. Additionally, existing fire-resistant materials may not be suitable for all vehicle applications due to weight, cost, or compatibility constraints. Traditional approaches to battery heat shield design rely on empirical testing, simplified heat transfer calculations, non-comprehensive physics simulation, and fireproof materials. These methods can be time-consuming, resource-intensive, and lack accuracy in predicting the complex transient temperature profiles during thermal runaway. Additionally, existing fire-resistant materials may not be suitable for all vehicle applications due to weight, cost, or compatibility constraints.

Empirical testing is limited to specific test scenarios and cannot predict behavior under varying conditions. Empirical testing is expensive making it difficult and time-consuming to optimize heat shield designs for specific situations. Simplified heat transfer calculations and non-comprehensive physics simulations use simplified and decoupled models that may not capture complex heat transfer dynamics, leading to inaccurate predictions. Also, they often focus solely on the battery pack, neglecting the broader thermal impact on the vehicle. Fireproofing materials have limited material options, weight and cost concerns and potential compatibility issues with other vehicle components.

### SUMMARY

This section provides a general summary of the disclosure and is not a comprehensive disclosure of its full scope or all of its features.

In one aspect of the disclosure, a method and system for designing a heat shield includes performing a thermal runaway analysis for a first battery pack design to obtain thermal runaway data, determining an initial heat shield design, determining vehicle analysis data using the thermal runaway data an ambient air temperature and a vehicle velocity and comparing the vehicle analysis data to design constraint data and safety data to obtain design guide performance parameters.

In another aspect of the disclosure, a heat shield design system includes a processor, a non-transitory computer readable medium including machine readable instructions that are executable by a processor, said machine readable instructions include, performing a thermal runaway analysis for a first battery pack design to obtain thermal runaway data, determining an initial heat shield design, determining vehicle analysis data using the thermal runaway data an ambient air temperature and a vehicle velocity and comparing the vehicle analysis data to design constraint data and safety data to obtain design guide performance parameters.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of a vehicle having a heat shield.

FIG. 2 is a block diagrammatic view of a heat shield design device.

FIG. 3 is a flowchart of a method for designing a heat shield.

Corresponding reference numerals indicate corresponding parts throughout the several views of the drawings.

### DETAILED DESCRIPTION

Example embodiments will now be described more fully with reference to the accompanying drawings.

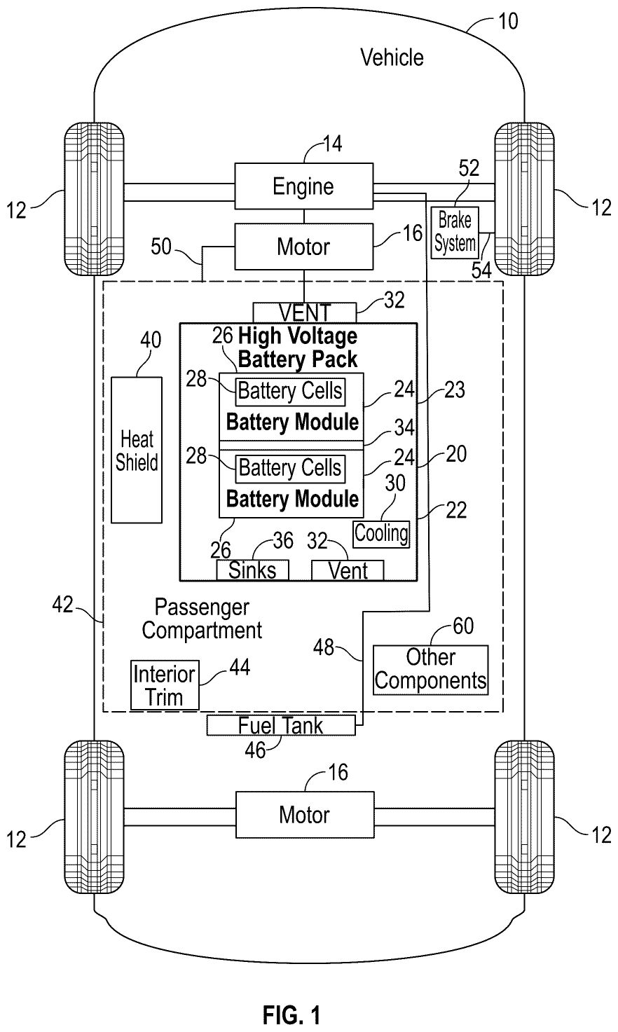

Referring now to FIG. 1, a block diagrammatic representation of a vehicle 10 is shown. The vehicle has a plurality of wheels 12 that are powered by an engine 14, electric motors 16 or combinations of both. That is, the vehicle 10 may be a battery electric vehicle or a hybrid electric vehicle. The vehicle 10 has a high voltage battery pack 20 that has a plurality of walls 22 that form a battery pack housing 23 that enclose a plurality of battery modules 24. The plurality of battery modules 24 have a housing 26 that enclose a plurality of battery cells 28. The battery pack 20 may have various battery pack layouts and components such as cooling components, thermal isolation layers and different chemistries within each of the battery cells 28. The position of the battery modules 24 and the battery cells 28 are referred to as the battery cell layout. Although only two battery modules 24 are illustrated, a large number of battery modules 24 are likely in any particular vehicle. Various numbers of battery cells 28 are provided in each of the battery modules 24.

Various cooling structures 30 may also be provided within the battery pack 20. Likewise, various numbers of vents 32 may be provided. In this example, two vents 32 located on the longitudinal ends of the battery pack 20 are illustrated. However, various numbers of vents 32 may be provided.

In summary, the battery cells 28 each have a chemistry, a layout and construction. The battery modules 24 have a housing and thermal isolation layers 34. The battery pack 20 may have various layouts depending upon the type of vehicle and the vehicle geometry. The battery pack 20 may also have various components, such as cooling components 30, disposed therein. The battery pack 20 may also have a plurality of vents 32 that are disposed in various locations and may be various sizes. Further, a plurality of heat sinks 36, one of which is illustrated, may be employed to remove heat.

A heat shield 40 is disposed adjacent to the battery pack 20. In this illustration, the heat shield 40 is located next to the battery pack 20 for convenience of the drawing. However, the heat shield 40 may be disposed in various positions including between the passenger compartment 42 and the battery pack 20. The passenger compartment 42 has interior trim 44.

The vehicle 10 may also include a fuel tank 46 that is coupled to the engine 14 through a fuel line 48. Cables 50 may also connect a plurality of different components such as the battery pack 20 and the motor 16.

The vehicle 10 may also have a brake system 52 with a brake line 54 that is coupled to each of the wheels 12 to stop the vehicle 10. Each of the above-mentioned components has a smoking or melting point for which it is desirable to keep the temperature below during operation. The present disclosure focuses on providing the heat shield 40 in various locations that is formed of selected materials to prevent overheating of various vehicle components. The heat shield 40 may be one continuous component or a plurality of individual portions.

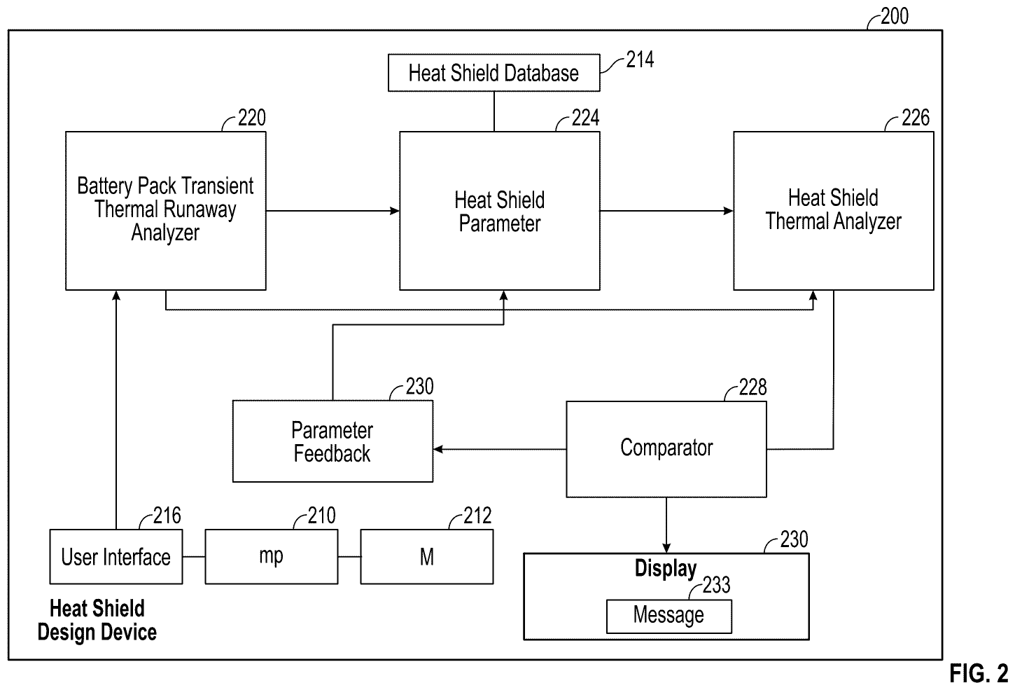

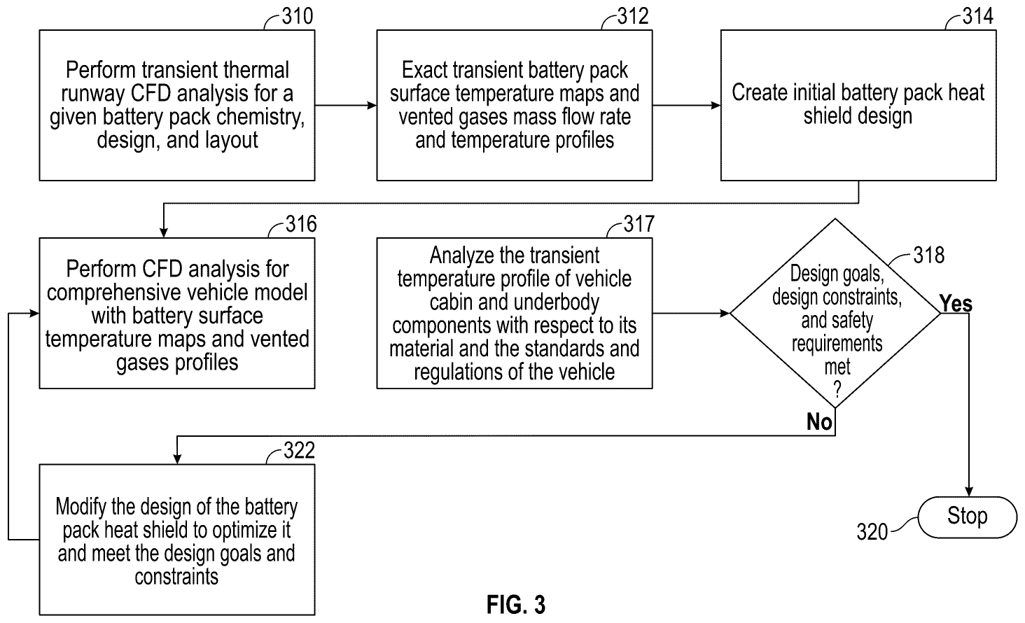

Referring now to FIGS. 2 and 3, a heat shield design device 200 and a method for designing are set forth. The heat shield design device 200 may comprise a microprocessor or processor 210 in communication with a memory 212. The memory 212 may be used for storing a heat shield database 214 with heat shield components (materials) and physical characteristics. The memory 212 is a non-transitory computer readable medium including machine readable instructions that are executable by the processor 210 that perform the various determinations for selecting and forming a heat shield. The microprocessor 210 may also be coupled to a user interface 216 such as a keyboard, touch screen or another data entry device.

The heat shield design device 200 may be formed of one component or a plurality of components that intercommunicate to form a heat shield design. The heat shield design device 200 is specifically used to design a heat shield for protection of the vehicle during a thermal runaway of the battery pack 20 of FIG. 1.

A battery pack transient thermal runaway analyzer 220 is used in step 310 to predict the transient battery surface temperature during thermal runaway using three dimensional analysis, based on the battery pack design selected by the user interface 216 or another type of data entry device. The design may be provided in a computer aided design (CAD) model. The battery pack transient thermal runaway analyzer 220 uses several of the following including battery cell chemistry, the battery cell layout, the battery cell construction, the battery module housing and thermal isolation layer composition and layout, the battery pack layout and components, the battery pack vent sizes and locations as inputs. The battery pack transient thermal runaway analyzer 220 performs a transient thermal runaway computational fluid dynamics (CFD) simulation that is used to analyze the heat transfer and fluid flow inside the battery pack and outside the vehicle. The material properties of the battery pack, a heat shield and surrounding components are taken into consideration. Heat transfer, heat generation and dissipation mechanisms like conduction, convection and radiation are taken into account in the battery pack transient thermal analyzer 220.

The battery pack transient thermal runaway analyzer 220 includes a multi-physics CFD model that includes biconjugate heat transfer, electrochemical reactions, magnetohydrodynamics, combustion, mass transfer, gas dynamics and solid particle dynamics. The output of the analyzer in step 312 is a surface temperature map of the battery pack and a vented gas flow rate and temperature profile that corresponds to the vented gases. The battery pack transient thermal runaway analyzer 220 ultimately extracts a temporal and spatial temperature map of the battery pack from the thermal runaway CFD analysis. The transient mass of flow rate and temperature of the gases that are vented from the battery pack are also determined by the thermal runaway CFD analysis performed by the analyzer 220. The analyzer 220 may provide various types of data with various time scales. The analyzer 220 extracts only data with time scales that are relative to the required accuracy of the subsequent steps.

In a heat shield parameter block 224, the heat shield parameter selector is used for selecting heat shield parameters for a heat shield that are provided to the heat shield thermal analyzer 226. In step 314, the initial battery pack heat shield design is created and the parameters such as materials and material characteristics or properties therefore are communicated to the heat shield analyzer 226. Ultimately, various heat shield parameters may be entered from the user interface 216 and may be looked up in terms of the physical characteristics in the heat shield database 214.

It should be noted that the heat shield parameter may provide no heat shield in the first iteration of the system.

The heat shield analyzer 226 uses the battery surface temperature map and the vented gas mass flow rate and temperature profiles to predict the transient temperature of all the components in the vehicle during a thermal runaway event. Various components may be provided to heat shield analyzer including the various components such as those illustrated above such as the brake lines, the fuel lines, the interior trim and various other components 60 if needed.

The CFD analysis is performed in step 316 for the comprehensive vehicle model with the battery surface temperature maps and vented gas mass flow rate and temperature profiles. The boundary conditions may include a transient spatially varying battery surface temperature map extracted above the transient mass flow rate and temperature of the vented gases from the battery at the various vent locations and the ambient air temperature and velocity surrounding the vehicle. The velocity and air temperature may be selected at the user interface 216. In step 317, the output of the heat shield thermal analyzer 226 is a transient temperature profile of all the vehicle components specified at the heat shield thermal analyzer 226. The transient temperature limits are deduced based on the materials of the components and the vehicle safety standards and the regulation requirements. In step 318 and at the comparator 228, the heat shield design is compared to various design limits and safety goals. When the comparator 2280 determines that the heat shield design is within the design limits and goals, the display 230 displays a message 233 indicating that the heat shield design meets the standards. The performance limits and goals include the vehicle thermal behavior during thermal runaway, the weight, the noise vibration and harshness (NVH) and the cost. When the heat shield design does not meet the various criteria in the comparator 228, step 322 and display 230 provide parameter peak feedback to the heat shield parameter block 224. In this manner, the design of the battery pack heat shield may be optimized to meet the design goals and constraints. The performance and cost issues may be addressed by obtaining different materials and material data from the heat shield database 214. Automatic optimization may take place at the heat shield parameter block 224 using a neural network, generic algorithms or adjoint optimization. The design guide performance and metrics from the CFD analysis in the heat shield analyzer 226 may be used to guide the design process. The parameters obtained from the heat shield analyzer 226 may include the detailed heat transfer network path breakdown, thermal inertia and thermal isolation as well as the heat from the vents and the sinks.

When the design goals have been met in step 318, step 320 stops the process and generates the display 230 illustrated. The message 233 may also provide instructions for initiating an input from the user to continue the process for further heat shield development.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
performing a thermal runaway analysis for a first battery pack design to obtain thermal runaway data;
determining an initial heat shield design;
determining vehicle analysis data using the thermal runaway data an ambient air temperature and a vehicle velocity; and
comparing the vehicle analysis data to design constraint data and safety data to obtain design guide performance parameters.

2. The method of claim 1 further comprising modifying the design based on comparing.

3. The method of claim 2 wherein modifying the design comprises modifying the design based on at least one of heat transfer network paths, thermal inertia, thermal isolation and a number of heat sinks or vents, or both.

4. The method of claim 2 wherein modifying the design comprises modifying the design based on at least two of heat transfer network paths, thermal inertia, thermal isolation and a number of heat sinks or vents, or both.

5. The method of claim 4 wherein modifying the design comprises modifying the design at a neural network.

6. The method of claim 2 wherein performing the thermal runaway analysis comprises performing the thermal runaway analysis to obtain transient battery surface temperature maps.

7. The method of claim 1 wherein performing the thermal runaway analysis comprises performing the thermal runaway analysis to obtain temporal and spatial temperature maps.

8. The method of claim 1 wherein performing the thermal runaway analysis comprises performing the thermal runaway data to obtain transient battery surface temperature maps and vented gas mass flow rate and temperature profiles.

9. The method of claim 1 wherein performing the thermal runaway analysis comprises performing the thermal runaway data to obtain vented gas mass flow rate and temperature profiles.

10. The method of claim 1 wherein performing the thermal runaway analysis comprises performing a three-dimensional analysis.

11. The method of claim 1 wherein performing the thermal runaway analysis comprises performing a three-dimensional analysis using computed fluid dynamics.

12. The method of claim 1 wherein performing the thermal runaway analysis comprises performing a three-dimensional analysis using computed fluid dynamics.

13. The method of claim 12 wherein performing the three-dimensional analysis using computed fluid dynamics comprises performing the three-dimensional analysis using computed fluid dynamics based on biconjugate heat transfer, electrochemical reactions, magnetohydrodynamics combustion, mass transfer gas dynamics or solid particle dynamics, or combinations thereof.

14. The method of claim 1 wherein performing the thermal runaway analysis for the first battery pack comprises performing the thermal runaway analysis for the first battery pack based on battery cell chemistry, battery cell layout, battery cell construction, battery module housing material. battery module thermal isolation layers, battery pack layout components, battery pack vent sizes and battery pack locations.

15. The method of claim 1 wherein performing the thermal runaway analysis for the first battery pack comprises performing the thermal runaway analysis for the first battery pack based on battery cell chemistry, battery cell layout, battery cell construction, battery module housing material, battery module thermal isolation layers, battery pack layout components, battery pack vent sizes and battery pack locations.

16. A heat shield design system comprising:
a processor;
a non-transitory computer readable medium including machine readable instructions that are executable by a processor, said machine readable instructions include,
performing a thermal runaway analysis for a first battery pack design to obtain thermal runaway data;
determining an initial heat shield design;
determining vehicle analysis data using the thermal runaway data an ambient air temperature and a vehicle velocity; and
comparing the vehicle analysis data to design constraint data and safety data to obtain design guide performance parameters.

17. The system of claim 16 wherein the instructions include modifying the design based on comparing.

18. The system of claim 17 wherein the instruction for modifying the design comprises modifying the design based on at least one of heat transfer network paths, thermal inertia, thermal isolation and a number of heat sinks or vents, or both.

19. The system of claim 18 wherein the instructions for modifying the design comprises modifying the design at a neural network and further comprising a display displaying a message after determining the vehicle analysis.

20. The system of claim 16 wherein the instructions for performing the thermal runaway analysis comprises performing a three-dimensional analysis using computed fluid dynamics.
